(19) United States
(12) Patent Application Publication
(10) Pub. No.: US 2022/0205380 A1
(43) Pub. Date: Jun. 30, 2022

(54) A MODULARIZED CATALYTIC CONVERTER AND A METHOD OF ENHANCING THE EFFICIENCY OF A CATALYTIC CONVERTER

(71) Applicant: Vestlandets Innovasjonsselskap AS, Bergen (NO)

(72) Inventor: Lars Magne NERHEIM, Hordvik (NO)

(21) Appl. No.: 17/613,007

(22) PCT Filed: May 19, 2020
(86) PCT No.: PCT/NO2020/050127

§ 371 Date: Nov. 19, 2021

(30) Foreign Application Priority Data
May 21, 2019 (NO) 20190635

(51) Int. Cl. F01N 13/00; F01N 3/20; F01N 5/04; F02C 1/00; B01D 53/94

(52) U.S. Cl. CPC F01N 13/0097; F01N 3/2013; F01N 3/2066; F05D 2220/76; F02C 1/00; B01D 53/9477; F05D 2220/40; F01N 5/04

(57) ABSTRACT

A catalytic converter module assembly comprises a plurality of catalytic converter modules arranged in series such that gas may be fed through successive catalytic converter modules. Each catalytic converter module comprises a catalytic converter having one or more catalytic converter members arranged and configured for fluid contact with a gas, and a heat generator arranged close to and upstream of the catalytic converter. The heat generator and the catalytic converter are arranged in fluid communication and interconnected by connection means so as to form a unitary device. The invention allows for heating a gas flowing past the heat generator substantially immediately before the gas is exposed to the catalytic converter or catalytic converter member, whereby the efficiency of a catalytic converter is enhanced. The invention is particularly useful for cleaning non-combusted hydrocarbons, such as methane, carbon monoxide, or nitrogen oxides, in the exhaust gas.

### FIELD OF THE INVENTION

The invention concerns the thermal treatment of exhaust gases or fumes from various industrial processes, such as process plants, internal combustion engines, gas turbines, boilers, etc., in particular gases containing traces of methane. More specifically, the invention concerns a module-based catalytic converter and a method of enhancing the efficiency of a catalytic converter by applying electrical energy in a special way from an external source.

### BACKGROUND OF THE INVENTION

Various energy gases, such as natural gas (NG), biogas (BG), etc., contain methane (CH₄) as their main energy-carrying component. Methane-based fuels are becoming increasingly popular in various types of combustion machinery because of their low-polluting combustion characteristics and favourable low carbon content (low CO₂ emissions per unit of energy produced).

However, as methane is a very stable gas, it is both difficult to ignite and burn completely. In addition, modern combustion machinery mostly operate with a high air excess (“lean burn”) in order to increase their efficiency and limit the formation of nitrogen oxides (NOx) (which is mainly a temperature issue). This relatively cold combustion might have difficulty in fully burning all the (stable) methane fuel, so that a small amount of partly burnt or un-burnt hydrocarbons (UHC)—particularly methane—might get emitted with the exhaust gases into the atmosphere.

In recent years, along with the global warming concern and awareness of the “greenhouse effect” of various gases, this “methane slip”, although normally quite small, has become of growing concern. This is because of the very strong greenhouse effect of methane, currently assumed to be 28 times higher than that of CO₂. Hence, methane emissions of all types, and particularly in the exhaust gases of combustion machinery, are rapidly gaining serious attention by the regulatory bodies and of society in general.

Development of efficient types of methane catalysts for the elimination of this “methane slip” has been going on for many years. However, the combination of low exhaust gas temperatures of modern gas combustion concepts in combination with the stability of methane to get oxidized, has so far not led to any successful or efficient types of methane exhaust catalysts for practical use with combustion machinery.

This is even a greater problem in industrial treatment of “ventilation gases” or “fumes” containing methane, as these normally are of moderate or ambient temperature.

Thus, the efficiency of most exhaust gas cleaning devices depends on the gas temperature. Catalytic converters require a certain minimum temperature in order for the catalyst to start reacting with the exhaust gas. The cleaning efficiency of gas cleaning devices such as filters, scrubbers, etc., is also dependent on the exhaust gas temperature. One problem with prior art systems is that the exhaust gas temperature is too low, whereby the cleaning efficiency suffers. An essential objective of the invention is to improve the efficiency (performance) of the gas-cleaning device (i.a. catalytic converter) in applications with low exhaust temperatures.

The prior art includes JPH09100715A, which describes an exhaust emission control system for an internal combustion engine. The system comprises a branch passage which bypasses a part of an exhaust passage. An exhaust change-over valve is switched by a controller and when an electric heating type catalyst is made conductive, the exhaust passage is shut off by the controller and the exhaust gas is caused to flow through the branch passage. Then, power obtained by the generator is supplied to the electric heating type catalyst. Thus, the starting failure of the internal combustion engine and the deterioration of a battery are prevented. In the engine, a generator is provided in the middle of the exhaust passage to generate electric power by the exhaust gas flow flowing in the passage, and when the electrically heated catalyst becomes energized, the electric power obtained by the generator is electrically heated. And the generator is connected to the electrically heated catalyst.

The prior art also includes U.S. Pat. No. 8,992,843B2, which discloses a catalytic converter for confined areas, e.g. a vehicular tunnel, parking garage, or other confined area subject to motor vehicle operation therein. The converter catalyses internal combustion engine exhaust by-products by selective catalytic reduction. The heat required for the catalytic reaction is provided by an electric heater installed with the converter, the converter being thermally insulated to retain the heat. The catalytic converter includes at least one electric heating element disposed within a housing and adjacent to the catalytic converter elements, the electric heating elements extending substantially from the first end to the second end of the housing. The heating elements are preferably immediately adjacent to the catalytic converter elements, enclosed within thermal insulation and a ceramic shell with the catalytic converter elements in order to maximize heating efficiency of the elements. Electrical power for the heating elements may be provided by any suitable conventional means.

The prior art also includes JP H051525 A, which discloses an electrically powered ribbon heater placed upstream of a catalytic converter. The assembly is installed to an exhaust passage or a bypass in an internal combustion engine, and the ribbon heater is energized to heat the catalyst to an activation temperature.

There is a need to provide catalytic converters that are more efficient and compact than those of the prior art, particularly for use in systems where gases containing UHCs, in particular methane, are vented to the atmosphere, and in confined spaces such as engine compartments for automobiles, lorries and seagoing vessels.

### SUMMARY OF THE INVENTION

The invention is set forth and characterized in the main claims, while the dependent claims describe other characteristics of the invention.

It is thus provided a catalytic converter module assembly, characterized by a plurality of catalytic converter modules arranged in series such that a gas may be fed through successive catalytic converter modules and treated in stages. A catalytic converter module comprises a catalytic converter having one or more catalytic converter members arranged and configured for fluid contact with a gas to be treated by the catalytic converter, characterized in that the catalytic converter module further comprises a heat generator arranged adjacent to and upstream of the catalytic converter; and the heat generator and the catalytic converter are arranged in fluid communication and interconnected by connection means so as to form a unitary device (module).

In one embodiment, the heat generator is arranged a distance upstream of the catalytic converter and a gas reaction zone is defined between at least one heating member in the heat generator and said one or more catalytic converter members. Said distance may be zero, in which case the heat generator and catalytic converter are arranged immediately adjacent to one another as a common unit (mesh). The connection means may be a clamp assembly.

In one embodiment, the heat generator and the catalytic converter are of screen-type designs. The catalytic converter module is preferably arranged inside a thermally insulated conduit. The heat generator may comprise one or more heating members. The heat generator may comprise one or more turbulators.

The catalytic converter modules may have different catalyst material.

It is also provided a cleaning assembly for treating exhaust gases from a thermal engine, characterized by an exhaust gas turbine, fluidly connected to an exhaust gas conduit of the thermal engine and arranged to receive exhaust gas, the catalytic converter assembly according to the invention, configured for receiving the exhaust gas and for heating and treating the gas. The cleaning assembly may further comprise an electric generator driven by the exhaust gas turbine. In one embodiment, the catalytic converter assembly is arranged upstream of the exhaust gas turbine. A catalytic converter assembly may also or additionally be arranged downstream of the exhaust gas turbine. The thermal engine may be an internal combustion engine.

It is also provided a method of enhancing the efficiency of a catalytic converter, characterized by providing a localized heat generator at a distance upstream of a catalytic converter or catalytic converter member (2a), and energizing the heat generator to heat a gas flowing past the heat generator substantially immediately before the gas is exposed to the catalytic converter or catalytic converter member and optimize heat input and catalytic contact area of the gas to be treated when flowing through the catalytic converter module (1). The distance may be zero, in which case the heat generator and catalytic converter are arranged immediately adjacent to one another as a common unit.

It is also provided a method of treating a gas, characterized by subjecting the gas to repeated heating and cleaning stages as it passes through successive catalytic converter modules. The heat may be generated in such a way as to optimize the temperature profile permanently or temporarily depending on the system operating conditions.

This invention is a result of a comprehensive involvement with methane-combusting machinery of different types, and profound studies into both the problem of “methane slip”, as well as developments of efficient methane exhaust catalysts. This has led to a novel and inventive approach, where electrical heating is used as additional energy applied in a novel way to create particularly favourable oxidation conditions for any methane in the exhaust stream, in order to limit the amount of energy needed. This new concept may also be applied in other types of oxidizing exhaust catalysts.

The invention comprises a localized heat generator arranged close to a catalytic converter in order to increase the temperature in a gas immediately before it is exposed to the catalytic converter, which in combination create a local hot reacting zone.

The invention is particularly useful for treating (cleaning) non-combusted hydrocarbons, such as methane, carbon monoxide, etc., in exhaust gases or in a ventilation gas stream.

### BRIEF DESCRIPTION OF THE DRAWINGS

These and other characteristics of the invention will become clear from the following description of embodiments of the invention, given as a non-restrictive examples, with reference to the attached schematic drawings, wherein:

FIG. 1 is a schematic sectional drawing of an embodiment of the catalytic converter module according to the invention, illustrating a typical arrangement of a heat generator in combination with a catalytic converter unit;

FIG. 2 is a perspective drawing, schematically illustrating an array of catalytic converter modules according to the invention arranged one downstream of the other, as a unitary package;

FIG. 3 is a schematic sectional drawing corresponding to FIG. 1, but illustrates an embodiment having turbulence-inducing heat generators;

FIG. 4 is a perspective drawing, schematically illustrating an alternative embodiment of the invention in which the catalytic converter module comprises a unit in which the catalytic converter members and heating members are combined into one unit where the catalytic converter members and heating members form a common mesh structure; and

FIG. 5 is diagram illustrating a system incorporating the catalytic converter module according to the invention used in association with an internal combustion engine.

### DETAILED DESCRIPTION OF EMBODIMENTS OF THE INVENTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

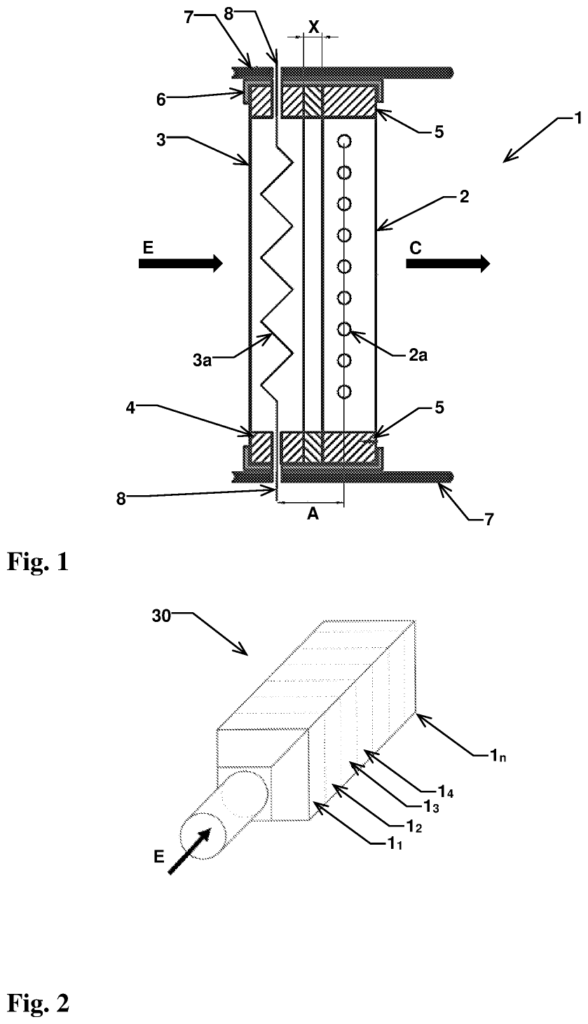

Referring initially to FIG. 1, the invented catalytic converter module 1 comprises in the illustrated embodiment a catalytic converter 2 and a heat generator 3 arranged upstream and a short distance from of the catalytic converter 2. The heat generator 3 is illustrated as an electrically powered heat generator, having one or more heating members 3a in the form of resistance wires and a power cable 8 connected to an electrical power source (not shown). The heating members 3a are arranged in an electrically insulated housing 4. It should be understood that the heating member 3a may be any type of electrical heating source (e.g. positive temperature coefficient (PTC) element or resistance wire).

The catalytic converter 2 comprises a plurality of catalytic converter members 2a, such members per se being known in the art. These catalytic converter members are arranged in a frame 5 and such that they are exposed to gases flowing through the catalytic converter. Reference letter A denotes the center-to-center distance between the catalytic converter member 2a and the heating member 3a and defines a gas reaction zone A within the catalytic converter module 1.

The heat generator 3 is arranged adjacent to, and a distance X upstream of, the catalytic converter 2, and is connected to the catalytic converter 2 by connection means 6, here in the form of a clamp assembly 6. Although not illustrated, it should be understood that the connection means 6 may comprise bolts, adhesives and/or any other bonding means, and not be limited to the illustrated clamp assembly. The heat generator 3 and the catalytic converter 2 may in a preferred embodiment both be of screen-type designs, but other designs are conceivable. The distance X may be dimensioned according to the application at hand, and may range from zero to several centimetres. The combined effect of the heat generator 3 and the catalytic converter 2 together produces the cleaning reaction depending on various parameters, of which the size of the reaction zone A is of importance. The distance X, which may be defined a spacer element, ensures that the heat generator and catalytic converter are maintained at the right distance, and by changing the distance X, the extension of the reaction zone A may be optimized.

The catalytic converter module 1 is arranged inside a conduit 7, which may be a thermally insulated duct. Although not illustrated, the conduit 7 and the catalytic converter module 1 may have a circular cross-section or a rectangular cross-section. The invention shall not be limited to cross-sectional shape. A plurality of catalytic converter modules 1₁, 1₂, . . . 1ₙ may thus be arranged one downstream of the other, in an array (assembly) 30, as illustrated in FIG. 2, in order to enhance cleaning effect. One or more individual catalytic converter modules 1ₙ may be removed for cleaning or inspection purposes, replacement, etc. Also, the array (assembly) 30 may comprise catalytic converter modules having different properties (e.g. catalyst material), depending on the application.

The “stacking” of catalytic converter modules 1 as shown in FIG. 2 may enable optimization of important reaction parameters such as temperature, residence time, flow conditions, catalyst material, etc. to the given exhaust treatment process(es). The exhaust gas is subjected to repeated heating and cleaning stages as it passes through successive catalytic converter modules 1₁, 1₂, . . . 1ₙ.

In use, untreated exhaust gas E enters the heat generator 3 where it is exposed to high local temperatures in a zone of very limited axial distance before it immediately thereafter comes into contact with the catalytic converter members 2a in the catalytic converter 2. The arrow C in FIG. 1 denotes a treated gas.

The electric energy supplied to the heat generator 3 may be of a fixed amount or it may be actively controlled from a suitable unit (not shown). In the latter case, it is typically arranged as a closed-loop control system, where a feedback sensor(s) inside and/or downstream of the catalyst gives a signal back to the electric controller. The electric controller may further control the various electric heater members 3 individually and differently according to the system operation conditions. In this way, an active exhaust cleaning down to a pre-set emission value may be achieved, and the system may be safe-guarded.

The cleaning effect of a given catalytic converter module 1 is produced by the combined effect which the heat generator 3 and the catalytic converter 2 have on the exhaust stream E. In order to optimize this effect relative to the energy consumption, size etc., various ways of arranging the heat generator and catalytic converter within a module may be possible.

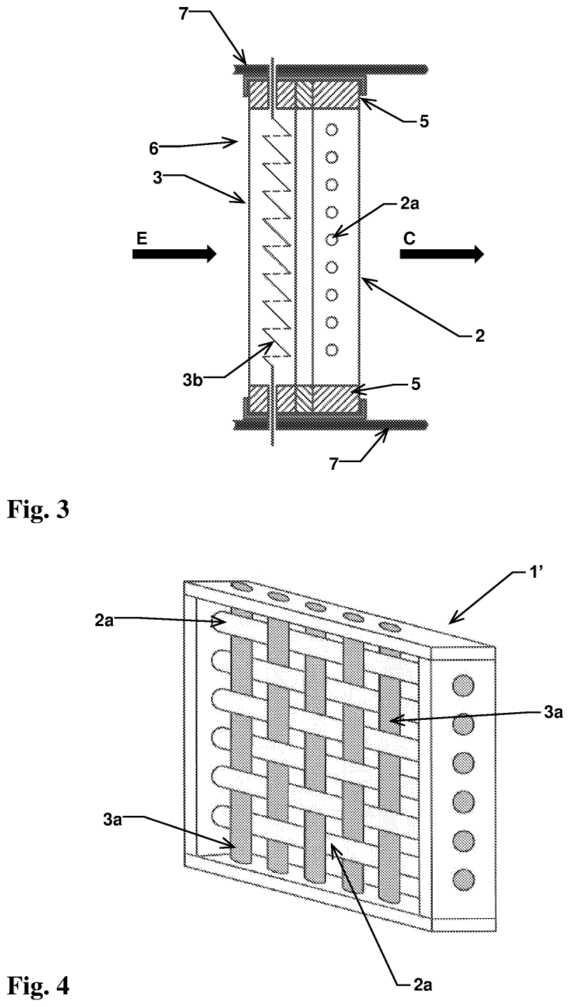

FIG. 3 illustrates another embodiment of the heat generator 3, in which one or more of the heating members 3b are shaped and arranged to function as turbulence generators. Although not illustrated, it should be understood that the heat generator may comprise heating members and turbulence generators also as separate members. The turbulence generators will influence the gas flowing though the reaction zone A, and thus contribute to improved cleaning efficiency for certain applications. The turbulence generators will also contribute to removing particles, oxides, etc., that may tend to accumulate in the catalytic converter with use.

FIG. 4 illustrates another embodiment of the catalytic converter module 1′, in which a plurality of catalytic converter members 2a and heating members 3b are shaped as elongated members and interconnected to form a common screen (mesh).

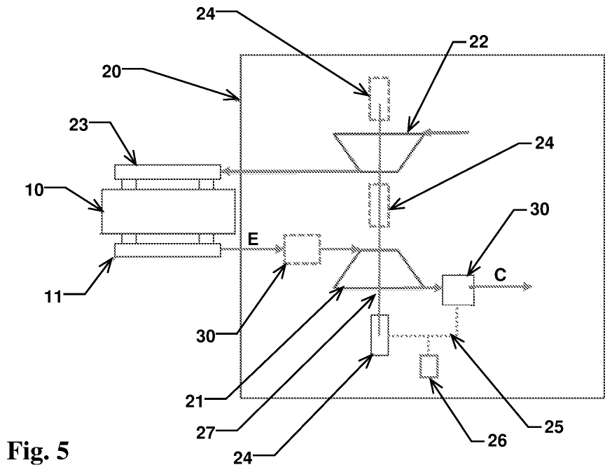

FIG. 5 illustrates an application of the invented catalytic converter assembly 30, arranged in a cleaning assembly 20 to treat exhaust gases from a thermal engine 10 (e.g. an internal combustion engine). The cleaning assembly 20 comprises an exhaust gas turbine 21, fluidly connected to the exhaust gas conduit (e.g. manifold) 11 of the thermal engine 10 and arranged to receive exhaust gas E. The exhaust gas turbine 21 is driving an electric generator 24 via a shaft 27, in a manner which per se is known in the art. The exhaust gas is fed into the catalytic converter assembly 30, which heats and treats (cleans) the gas as described above. Electrical power is supplied to the catalytic converter assembly 30 via power line 25. Reference number 26 denotes an external electrical power supply. Boxes drawn in dotted lines indicate alternative arrangements for the electric generator 24 and the catalytic converter assembly 30. The exhaust gas turbine 21 may also be driving an inlet compressor 22 which is fluidly connected to an inlet manifold 23.

The exhaust turbine 21 as well as the generator 24 may preferably be part of an exhaust turbocharger, and the turbocharger and catalytic converter assembly 30 may be arranged in a suitable way to make up a exhaust cleaning assembly 20.

1. A catalytic converter module assembly, comprising a plurality of catalytic converter modules arranged in series such that a gas may be fed through successive catalytic converter modules and treated in stages.

2. The catalytic converter module assembly of claim 1, wherein a catalytic converter module of the plurality of catalytic converter modules comprises:
a catalytic converter having one or more catalytic converter members arranged for fluid contact with the gas to be treated by the catalytic converter, and
an electrically powered heat generator arranged adjacent to and upstream of the catalytic converter;
wherein the heat generator and the catalytic converter are arranged in fluid communication and interconnected by a connection means so as to form a unitary device.

3. The catalytic converter module assembly of claim 2, wherein the heat generator is arranged a distance upstream of the catalytic converter, and a gas reaction zone is defined between at least one heating member in the heat generator and the one or more catalytic converter members.

4. The catalytic converter module assembly of claim 2, wherein the heat generator and the catalytic converter comprise screen-type designs.

5. The catalytic converter module assembly of claim 1, wherein the catalytic converter module assembly is arranged inside a thermally insulated conduit.

6. The catalytic converter module assembly of claim 2, wherein the heat generator comprises one or more heating members.

7. The catalytic converter module assembly of claim 2, wherein the heat generator comprises one or more turbulators.

8. The catalytic converter module assembly of claim 1, wherein the catalytic converter modules (have different catalyst material.

9. A cleaning assembly for treating exhaust gases from a thermal engine, comprising:
an exhaust gas turbine fluidly connected to an exhaust gas conduit of the thermal engine and arranged to receive exhaust gas;
a catalytic converter assembly configured for receiving the exhaust gas and for heating and treating the exhaust gas.

10. The cleaning assembly of claim 9, further comprising an electric generator driven by the exhaust gas turbine.

11. The cleaning assembly of claim 9, wherein the catalytic converter assembly is arranged upstream of the exhaust gas turbine.

12. The cleaning assembly of claim 9, wherein the catalytic converter assembly is arranged downstream of the exhaust gas turbine.

13. The cleaning assembly of claim 9, wherein the thermal engine is an internal combustion engine.

14. A method of enhancing an efficiency of a catalytic converter, the method comprising:
providing a localized heat generator a distance upstream of the catalytic converter or a catalytic converter member;
energizing the heat generator to heat a gas flowing past the heat generator substantially immediately before the gas is exposed to the catalytic converter or the catalytic converter member, and
optimizing a heat input and a catalytic contact area of the gas to be treated when flowing through the catalytic converter.

15. A method of treating a gas, comprising subjecting the gas to repeated heating and cleaning stages as it passes through successive catalytic converter modules.

16. The method of claim 15, wherein the heat is generated in such a way as to optimize a temperature profile permanently or temporarily depending on system operating conditions.
